(19) United States
(12) Patent Application Publication
(10) Pub. No.: US 2006/0260532 A1
(43) Pub. Date: Nov. 23, 2006

(54) Decorative display flag with horizontally disposed rigid wire for attachment to flag poles for residential and commercial display uses

(76) Inventor: Dale J. Hlavin, Westlake, OH (US)

Correspondence Address: HUDAK, SHUNK & FARINE, CO., L.P.A., 2020 FRONT STREET, SUITE 307, CUYAHOGA FALLS, OH, 44221, US

(21) Appl. No.: 11/488,474

(22) Filed: Jul. 18, 2006

Related U.S. Application Data
(63) Continuation-in-part of application No. 11/099,285, filed on Apr. 5, 2005, now Pat. No. 7,100,529.

(51) Int. Cl. G09F 17/00

(52) U.S. Cl. 116/174

(57) ABSTRACT

A decorative residential or commercial display flag for attachment to a supporting upright pole having flag attachment means comprising a linear sleeve adapted to loosely slip over the upright pole to enable lateral extension of the flag at right angles to the pole. The flag contains a horizontally directed rigid wire with an end connector aligned with the axis of the pole where the end connector engages an upwardly extending narrow pin located at the top of the upright pole. The connector contains an opening larger than the narrowed upright pin to enable the connector to slip over and engage the narrowed pin, while the opening is smaller than the upright pole to enable the larger diameter pole to vertically support the rigid wire. A locking nut on the narrow pin locks the wire connector to the pole to maintain the rigid wire horizontally disposed. The rigid wire supports the decorative flag vertically on the upright pole and sleeve enables preset outstretching of the flag perpendicular to the axis of the upright pole. The decorative flag can be attached directly to an upright pole. The rigid wire can be maintained laterally straight or can be bent to simulate a waving flag. Preferred flags are outdoors flags supported vertically by inserting the bottom end of the pole into a ground socket sunk into the ground flush with the ground, which permits expedient installation of the flag pole and easy removal of the pole for storage or rearrangement if desired. Alternatively the flagpole can be supported by a weighted holder resting on interior furniture or floors, or outside on a patio or other flat surface.

### RELATED PATENT INFORMATION

This application is a Continuation-in-Part Application of Co-pending U.S. patent application Ser. No. 11/099,285, filed Apr. 5, 2005 for Decorative Display Flag for Rotatable Attachments to Movable Poles For Residential and Commercial Uses”

### FIELD OF THE INVENTION

This invention pertains to decorative display flags on movable poles for exterior or interior use on residential and commercial properties to display decorative colors, graphics, numbers, lettering, or similar information display. The display flag comprises a vertical sleeve for attachment to the pole and an outstretched horizontally disposed sleeve containing a rigid support wire in locking engagement with the pole to maintain the flag in an outstretched right angle orientation in conjunction with direct attachment of the vertical sleeve to the pole.

### BACKGROUND OF THE INVENTION

Residential dwellers as well as commercial properties frequently like to display colorful decorative flags to attract attention or provide informative to the public. Such flags can be multiple color whimsical design of random or a set pattern of colors, graphics, numbers, lettering or similar design identifying school or organization affiliation or advertising brand name colors or company colors and products, union or club affiliation, brand names, high school or collage colors and/or logos, professional sport team colors and logos, commercial names, sales information, national flags, patriotic and community displays, political information, as well as similar indicia decorative flags displaying personal information such as announcements for birthdays, anniversaries, marriages, awards, addresses, directions, building names or numbers, and the like. Co-pending and commonly assigned Ser. No. 11/099,285 discloses and claims a rotatable display flag for attachment to movable poles for residential and commercial uses.

Prior to this invention decorative display flags were frequently a simple cloth flag tied to poles or adapted to be tied to poles or some other structure by simple tie knot connections or some intervening mechanical interconnection. Flag poles for this purpose ordinarily are permanently fixed into the ground or securely attached to a structure to permit the flag pole to stand upright and permit the flag to hang down and then extend outwardly with the wind blowing. For instance, U.S. Pat. No. 5,572,835 discloses a flag pole permanently set in concrete and a flag attached to the pole by intervening heavy metal rings forming part of the pole assembly. Similarly U.S. Pat. No. 5,975,009 suggests wire retainer clips for attaching the flag to the pole, while U.S. Pat. No. 5,943,980 suggests connecting rings for connecting a banner to a pole, where multiple rigid metal connection assemblies are required for attaching and vertically supporting the flags on the poles. U.S. Pat. No. 5,253,608 discloses an angular flag pole assembly with attaching connectors 20 for securing the flag tightly to the angular pole. A boat antenna system is disclosed in U.S. Pat. No. 6,748,683 having a flag attached to a pole by intervening connectors with a separate extruded coupling means attached directly to the pole, while U.S. Pat. No. 4,024,833 discloses a burgee with a frame supported flag with intervening connectors coupled to a balancing loop secured to an upper rod for boats and yachts. Intervening mechanical connectors are difficult and cumbersome to assemble and disassemble necessitating existing poles to be retrofitted with connectors to hang a flag on a pole. Permanently anchored poles are difficult to remove from set locations and cannot be easily moved to change location of the flag pole or flag poles or rearrange multiple poles to change the overall flag display. In brisk winds, a hanging flag tied to a pole frequently wraps around the pole. Flags not securely tied or knotted to the pole can fall off due to the ties loosening. Smaller exterior or interior decorative flags were often permanently glued or otherwise permanently secured to sticks. Interior flags can be displayed in building lobbies or personal offices or conference rooms, while interior residential flags can be displayed in game rooms or family rooms. Although interior flags are not subjected to outside weather or wind, such flags ordinarily were permanently fixed to a pole thereby preventing easy detachment and interchangeability of multiple flags depending on the season or occasion. Although these problems were resolved in commonly assigned U.S. application Ser. No. 11/099,285 filed Apr. 5, 2005, the flags were not permanently outstretched and merely hung limply downwardly without the wind blowing. In essence, a brisk wind blowing past the flags was necessary to provide lateral extension of the flags. A lateral extension is important for flags intended to display information to the public generally. Some free flowing flags usefully indicate wind direction, such as flags displayed at outdoor sporting events. Accordingly, public viewing of informative printed on extended outstretched flags used indoors or outdoors is a highly desirable alternative to ordinary downwardly drooping information display flags.

### SUMMARY OF THE INVENTION

It now has been found that an improved self-supporting decorative or information display flag adapted to be attached to a vertically disposed upright pole enables the flag to be preset and maintained stretched laterally outwardly from the pole in a manner typically caused by a brisk wind blowing past the flag. The decorative display flag of this invention comprises a linear side attachment sleeve integral with the flag adapted to slip freely over the upright pole in conjunction with a horizontally laterally disposed rigid wire contained in an upper sleeve integral with the top of the flag. The rigid wire has a circular connector aligned axially with the pole for secure right angular attachment to the upright pole to maintain the flag permanently outstretched from the pole and provide full viewing of the entire flag at all times, regardless whether the wind is blowing or whether the flag is used indoors. The circular connector fits over an upwardly extending narrow diameter threaded screw extension at the top of the pole, while an internally threaded locking member on the pin locks the horizontally disposed rigid wire at a right angle to the pole in an outstretched laterally disposed direction. While the flag is maintained laterally outstretched, the flag side sleeve maintains simple direct attachment to the vertical pole and eliminates cumbersome intervening mechanical connectors and insecure attachments to the pole. Alternatively, the decorative flag and rigid wire insert can be bent in a preset bent format simulating a flag waving in the wind. Subsequently, the bent wire can be straightened out to again provide a stretched out non-waving flag. The waving flag or outstretched flag of this invention can be easily attached or detached from the pole and can be easily interchanged with other decorative display flags as desired or simply dismantled for storage. The flag can be used outdoors by inserting a flag pole into a ground socket designed to maintain the pole upright, while indoor use of interior poles can be supported by weighted holders resting on a floor or furniture. These and other advantages of this invention will become more apparent by referring to the drawings and detailed description of the invention.

### IN THE DRAWINGS

FIG. 1 is a front elevation view of an outdoor upright pole supporting the decorative flag of this invention;

FIG. 2 is a front elevation view similar to FIG. 1, but showing an indoor flag of this invention attached to an interior flag pole supported by a portable weighted holder shown in vertical section;

FIG. 3 is a front elevation view of the flag in FIG. 1 containing a tubular insert shown in partial section and assembled with the flag pole;

FIG. 4 is a front elevation view similar to FIG. 1, but showing the decorative flag in a preset waving flag format;

FIG. 5 is a top plan view of the rigid wire removed from the flag in FIG. 1;

FIG. 6 is a front elevation view of the rigid horizontal wire in FIG. 5 and

FIG. 7 is a top plan view of a bent wire removed from the waving flag shown in FIG. 4.

### DETAILED DESCRIPTION OF THE INVENTION

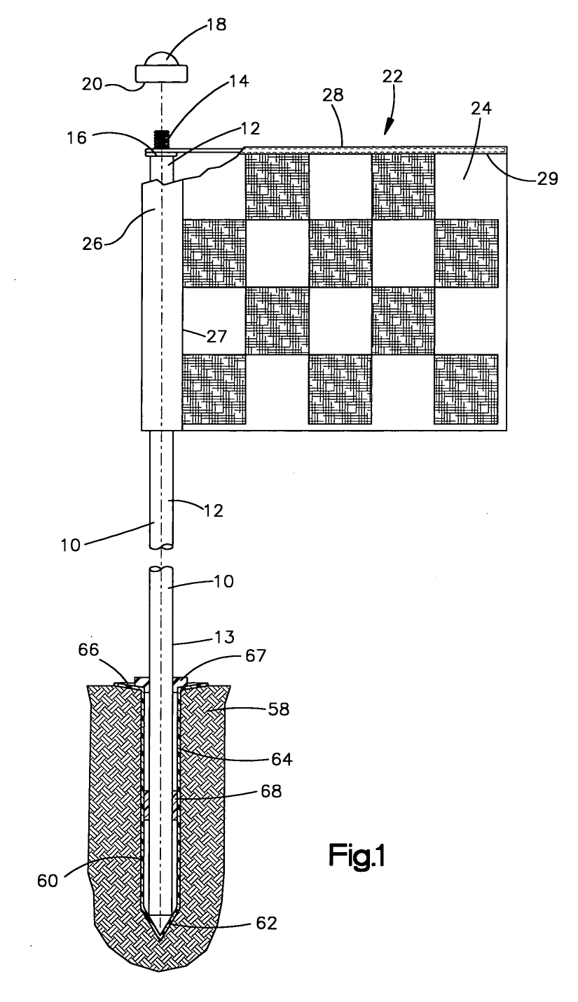

Referring now to the drawings wherein like reference numbers designate like parts, shown in FIG. 1 is a preferred embodiment of this invention showing a flag pole 10 with an exterior decorative flag 22 attached to the pole 10 in accordance with this invention. The flag pole 10 comprises an upper pole section 12 terminated at the top end with an upwardly extending smaller diameter pin or threaded screw 14. The juncture of the larger diameter pole 12 and the reduced diameter threaded pin or screw 14 forms an intervening laterally disposed peripheral shoulder 16. As shown in a partial broken away view, the upright threaded screw 14 is adapted to engage a threaded capping nut 18 having a lower edge 20 and internal threads with a threaded depth of the approximately length of threaded screw 14 to provide locking engagement between the capping nut 18 and the peripheral shoulder 16 when the capping nut 18 is tightened downwardly in accordance with the invention.

The decorative flag 22 of this invention comprises a preset outstretched field 24 normally displaying color designs and/or some sort of graphics, lettering or numbers or other indicia, as desired. The decorative flag 22 comprises a vertical hemmed sleeve 26 integral with the flag 22 on the left side of the field 24 and includes a horizontal hemmed sleeve 28 as part of the top of the flag 22, preferably integral with the top edge of flag 22. The horizontal narrow sleeve 28 is adapted to receive and contain a rigid horizontally extended supporting wire 30 functional to maintain the flag 22 laterally extended in an outstretched display. The rigid supporting wire 30 disposed inside the horizontal sleeve 28 ordinarily is in a preset outstretched straight horizontal configuration, as shown in FIG. 1, or alternatively can be formed into one or more bends 140 to form a rigid bent wire 130 to simulate a waving flag 122, as shown in FIG. 4. The flag 22 can be preset in an outstretched position, while flag 122 can be preset in a horizontal waving configuration. The bent wire 130 in flag 122 can be subsequently straightened out to again form an elongated outstretched wire 30 as originally provided and shown in FIG. 1. The rigid supporting horizontal wire 30 or bent wire 130 contains an exposed circular pole end connector 32 for axial alignment with the threaded pin 14, the pole 12 and the vertical sleeve 26. The connector 32 contains a circular internal opening 34 defined by a circular end configuration 35 adapted to slip over the upwardly extending threaded pin 14 to rest on and be supported by the peripheral shoulder 16 of the upper pole section 12. The end connector 32 can be other than circular, provided the connector 32 fits over the upright threaded pin 14 and rests on the peripheral shoulder 16, although circular is preferred in connection with a circular pole 12 and a circular threaded pin 14. The connector 32 can be a continuation of the rigid wire 30 formed into one or more circular turns 36, as shown in FIG. 6, to provide locking engagement with the nut 18, where two turns 36 resemble a lock washer. Similarly, the connector 32 could resemble a circular flat washer or other circular configuration 35 welded to the rigid wire 30. The inner diameter of the connector opening 34 is larger than the diameter of the threaded pin 14 but somewhat smaller than the outer diameter of the peripheral shoulder 16 to enable the connector configuration 35 to rest on the peripheral shoulder 16 when secured tightly with a capping nut 18. The capping nut 18 can be tightened downwardly on threaded pin 14 to securely lock the connector configuration 35 between the lowermost surface 20 of the locking nut 18 and the peripheral shoulder 16. Tightening the locking nut 18 maintains horizontal orientation of the rigid wire 30 and further prevents the rigid wire 30 from dislodging from the secure locking engagement of the connector 32 with the peripheral shoulder 16. The locking nut 18 shown in the drawings has a rounded head useful for aesthetic purposes, provided the locking nut 18 can be locked tightly against the connector configuration 35, although an ordinary conventional hexagonal open top locking nut can be used if desired or necessary if the threaded pin is vertically oversize. The rigid wire 30 size depends on the size and weight of the flag 22 or 122 being supported. A suitable wire for a 14 inch by 20 inch decorative flag is a 0.1205 gage galvanized basic steel wire about 17.5 inches long enabling extension beyond the open end of the 12 inch upper horizontal sleeve 28. Larger heavier flags may require a heavier gage wire. Minimum useful gage wire is about 0.118 gage wire. The wire 30 is rigid but sufficiently bendable to enable forming a bended wire 130 shown in FIG. 7. The rigid horizontal wire 30 maintains the flag 22 laterally outstretched to enable full viewing of the flag 22 regardless whether the wind is blowing outdoors or whether the flag 22 is used indoors.

In a desirable alternative aspect of this invention, the rigid wire 30 can be bent into a horizontally bends 140 in the disposed wavy extension wire 130 to cause vertical folds 138 to form in the outwardly extended wavy flag 122, as shown in FIG. 4. In this aspect of the invention, the flag 122 is maintained in a simulated waving flag with vertically orientated folds 138 as though a brisk wind was blowing and causing the flag 122 to be flapping in the wind, as may be expected outdoors. The waving flag 122 advantageously could be a well known flag, such as an American flag, as shown in FIG. 4, or otherwise recognizable wavy flag 122 desired to be displayed indoors or outdoors, and intended to be primarily decorative rather than contain public display information.

The vertical sleeve 26 of either flag 22 or waving flag 122 can be formed by sewing or otherwise securing the sleeve 26 at the seam 27 intervening between the sleeve 26 and the flag field 24. The sleeve 26 diameter is larger than the diameter of the upper pole section 12 to enable the decorative marking flag 22 or wavy flag 122 to freely slip over the top end of the upper pole portion 12. Horizontal sleeve 28 at the top of the flag 22 or wavy flag is relatively narrow and sufficient to freely receive and maintain the rigid wire 30 within the horizontal sleeve 28. The horizontal sleeve 28 can be formed by sewing or otherwise securing horizontal seam 29 at the top of the flag field 24 for the outstretched flag 22 or the wavy flag 122. The horizontal rigid wire 30 can be inserted into the horizontal sleeve 28 of the outstretched flag 22 or the waving flag 122 and then connected to pole 12.

In assembling flag 22 or flag 122 with a pole 12, the wire connector opening 34 is slipped over the upwardly extending threaded pin 14 to ride on and be supported by the peripheral shoulder 16 of the upper pole section 12. The inner diameter of the connector opening 34 is larger than the outside diameter of the upright threaded pin 14 to facilitate placing the opening 34 over the pin 14. The connector opening 34 is somewhat smaller than the outer diameter of the peripheral shoulder 16 to enable the connector 32 to ride on the peripheral shoulder 16. The wire 30 is locked by locking nut 18 and vertically supports the flag 22 in a preset outstretched format. The capping nut 18 is tightened down on threaded pin 14 to securely lock connector 32 to the top of the upper pole 12 to maintain horizontal direction of the rigid wire 30, and outstretched orientation of the marking flag 22.

A lower end pole section 13 shown in FIG. 1 is preferably inserted into a ground socket 60 disposed into ground 58. The ground socket 60 comprises a conical lower end point 62, a hollow cylindrical intermediate section 64 and a peripheral top collar 66 adapted to be set flush with the ground 58 and remain unobtrusive when not in use. If necessary, an elastomer plug 67 can be fitted into the ground socket opening to maintain centering of the pole section 13 within the ground socket 60 and/or a tightening sleeve or locking ferrule 68 can be fitted to the bottom section 13 of the pole 10, to provide a tight fit between the lower pole end 13 and the inside of the hollow cylinder 64 of the ground socket 60. The ground socket 60 can be sunk permanently into the ground 58 to support the flag pole 10 in accordance with this invention, although the ground socket 60 can be easily removed from the ground 58 with leverage if desired. The flag pole 10 can be easily and quickly removed from the ground socket 60 when desired. Meanwhile the flush set ground socket 60 remains unobtrusive to otherwise subsequent use of the same ground area. The ground socket 60 can be fitted with a protective plug to cap the opening of the ground socket from the elements while not in use. A 6 inch ground socket 60 is adequate for poles less than six feet, while a longer twelve inch ground socket 60 should be used for flag poles six to eight feet or taller. Poles 10 preferably are fiberglass but can be tubular metal or plastic extrusions or conventional solid wood. In a less preferred aspect of this invention, the bottom end 13 of the flag pole 10 can comprise a conical or other sharp edge point which can be inserted directly into the ground without the convenience of a ground socket 60. Flag poles 10 can comprise one or more sections coupled together.

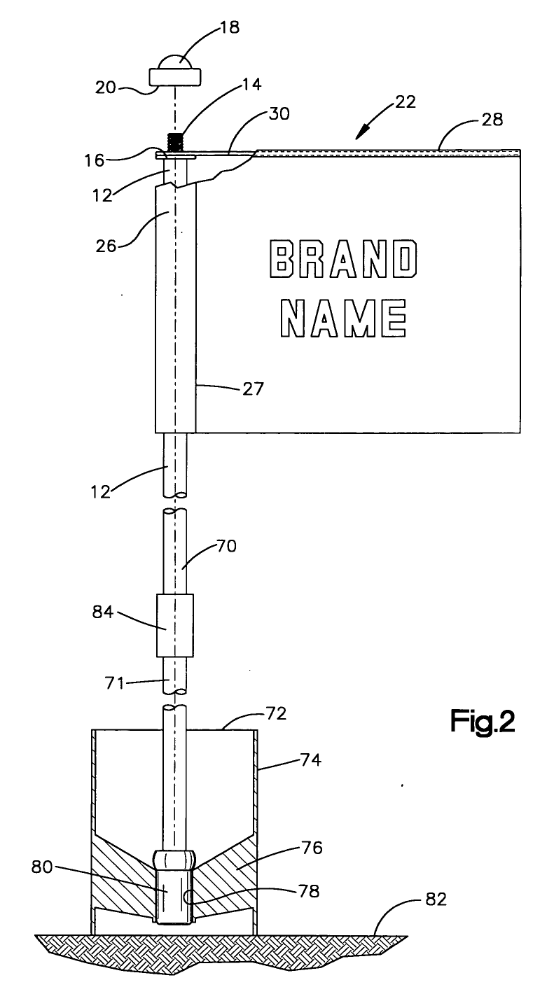

Alternatively, FIG. 2 illustrates an interior decorative flag 22 attached to a smaller pole assembly 70 and 71 supported by a weighted holder 72 shown in partial vertical sectional view. The flag 22 and pole 70 assemblies can be portable and primarily adapted for display inside residential homes or inside office buildings or other commercial buildings. The weighted holder 72 is shown as a cylindrical cup shape but can be square, triangular, hexagonal or other polygon shape as desired. Weighted holder 72 for flag pole 70 can be a novelty design such as an indoor putting cp, a miniature replica or symbol, or other configuration. The holder 72 shown in FIG. 2 comprises a peripheral cylinder 74 with internally directed braces 76 terminating internally with a circular juncture containing a round internal opening 78 adapted to vertically support lower pole section 71. Preferably a small ferrule 80 can be fitted to the bottom of pole section 71 to tightly engage the outer surface of the bottom most area of the pole 70. The ferrule 80 securely fits within the opening 78 to interface with the opening 70 while tightly engaging the bottom of the pole section 71. The weighted holder 72 can be cast metal such as brass or suitable fabricated metal or molded bottom weighted plastic to maintain the pole 70 and flag 22 upright in use. The weighted holder 72 is shown supported on a floor or table top 82 or other stable flat surface. The flag 22 in FIG. 2 is attached to upper pole section 70 in the same manner as flag 22 is attached to upper pole section 12 as shown in FIG. 1. Indoor poles 70 resting on furniture ordinarily are smaller typically about one to three feet high, while floor standing poles 70 are larger up to about six feet. Upper and lower pole sections 70 and 71 in FIG. 2 are shown coupled together with a coupling 84 tightly secured to the upper 70 and lower 71 pole section to provide a sturdy pole assembly. In like manner the upper and lower pole sections 12 and 13 shown in FIG. 1 can likewise be an assembled pole structure comprising two or more pole sections coupled together with a coupling 84. For commercial shipping purposes, flag poles 10 can be shipped as pole sections and then assembled as needed to provide a flag pole of a selected height. Advantageously upper pole sections have the coupling 84 secured to the lower end of the pole section 70 to facilitate assembly with a lower pole section 71. A three pole assembly for instance would have a coupling 84 secured to the lower end of the two upper pole sections to facilitate coupling with a lower pole section. The coupling 84 preferably is secured with glue to the upper pole section which seals and prevents rain water leakage within the coupling 84 for flag poles used outdoors. Pre-gluing the coupling 84 to the upper section of a flagpole facilitates secure slip fit assembly and enables disassembly of the pole sections, if desired. A useful coupling 84 can be an “H” shaped structure having an upper cup and lower cup for secure engagement with upper pole section 70 and lower pole section 71 respectively. The embodiment shown in FIG. 2 is primarily intended for inside use but can be used outdoors on a patio or door step. This configuration is portable and can be carried around as desired to mark parking areas or no parking areas, or to designate driveways, walkways and pathways.

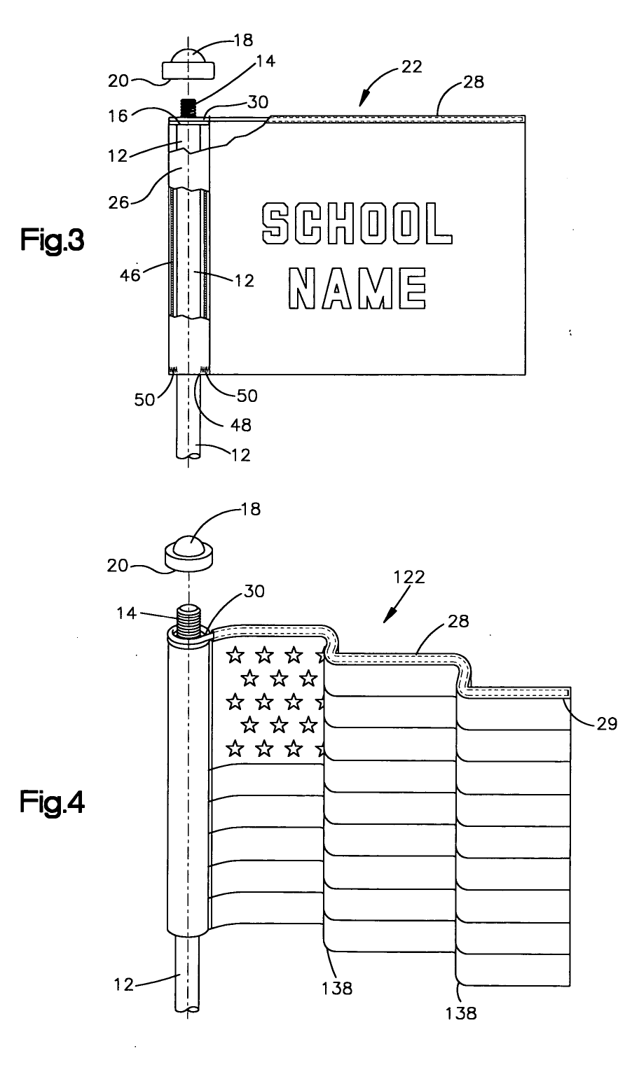

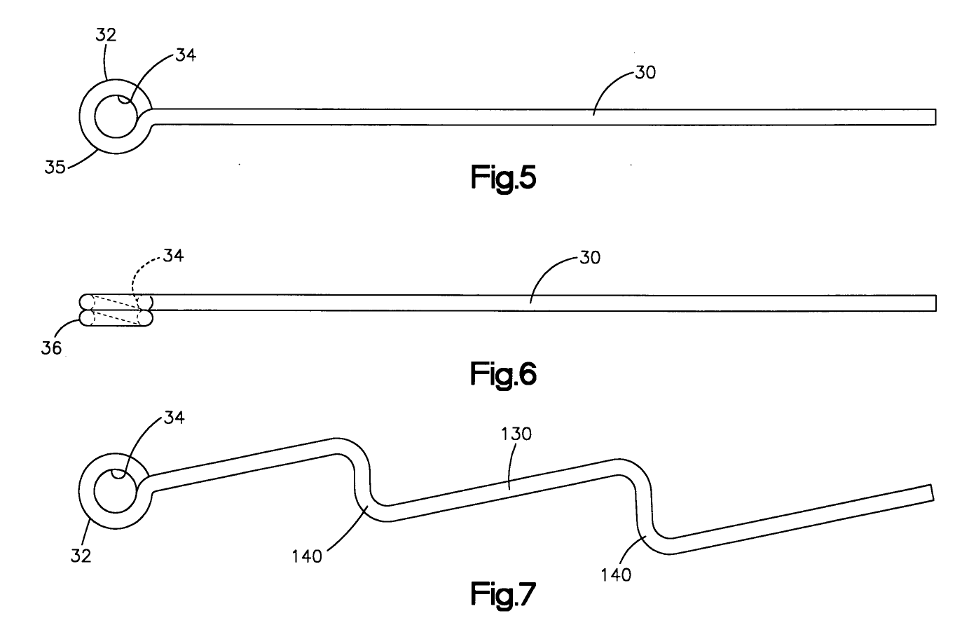

In a useful aspect of attaching the decorative flag 22 or flag 122 to the upper section 12 of upright pole 10, a cylindrical removable plastic hollow tube 46 can be inserted into the sleeve 26 to minimize wear and tear of the flag material against the upper pole section 12. The tube 46 provides extra support and wear resistance for the flag 22 and can be removed and reused in a replacement flag if desired. The plastic tube 46 is inserted within the sleeve 26, as viewed in FIG. 3, and can be maintained and supported within the sleeve 26 by a narrowed bottom opening 48 having a diameter smaller than the external diameter of the plastic tube 46. The bottom end of the sleeve 26 is partially closed by stitching to form a pinched bottom peripheral seam 50 defining the small bottom opening 48 adapted to receive the upper pole section 12. The narrowed opening 48 typically can be formed by partially sewing, gluing, crimping or otherwise partially securing the laterally disposed pinched peripheral bottom seam 50 of the sleeve 26. The surrounding larger diameter plastic tube 46 is vertically supported within the sleeve 26 by the pinched seam 50. The plastic tube insert 46 can be slipped into and retained within the sleeve 26 by the pinched bottom seam 50, while the entire flag 22 can be vertically supported by the rigid 30 wire securely locked at a right angle to the pole 12 by locking nut 18. Vertical support of the flag 22 is maintained by the wire 30 locked tightly to the pole 12 to maintain the rigid wire 30 in horizontal orientation. The foregoing descriptive orientation of the outstretched wire 30 is intended to pertain to both straight and wavy bending configurations shown FIGS. 1 and 4 respectively. The decorative flag of this invention can be directly attached to external or internal flag poles without the necessity of intervening mechanical connectors. The flags can be easily attached to or removed from poles or interchanged as desired, while poles supported by ground sockets, or bottom holes can be easily removed and stored or rearranged as desired. The decorative flags conventionally are about 20 inches by 14 inches and can be smaller or larger as desired as well as different shapes, provided that wire 30 or bent wire 130 is locked in right angular orientation with pole 12.

Although preferred aspects of the invention have been described and illustrated in the drawings the best mode and preferred embodiment have been set forth, the invention is not intended to be limited thereby. While in accordance with the patent statutes the best mode and preferred embodiment have been set forth, the scope of the invention is not limited except by the scope of the attached claims.

What is claimed is:

1. A decorative flag for attachment to an upright pole to provide a flag and pole assembly, the upright pole having an upwardly extending pin member attached to the upper end of the upright pole, the upwardly extending pin having a reduced thickness smaller than the thickness of the upright pole forming a peripheral lateral shoulder at the juncture of the upwardly extending pin and the upper terminal end of the upright pole, the decorative flag adapted to be readily attachable and detachable from the pole, the decorative flag and pole comprising:
a flag having an attachment side for interconnection with the upright pole, the attachment side having a vertically orientated linear sleeve adapted to slip over the upright pole and provide direct attachment of the flag to the upright pole;
the flag having a narrow horizontal lateral top sleeve disposed perpendicular to the vertical sleeve, the horizontal sleeve containing a horizontal rigid wire for supporting the flag vertically and maintaining the flag laterally outstretched from the vertical sleeve, the rigid wire having an exposed end connector disposed in alignment with the upright pole, the end connector having an opening large enough to engage the upwardly extending pin but smaller than the thickness of the upright pole to enable the connector to rest upon the peripheral lateral shoulder between the upright pin and the upper terminal end of the upright pole;
a locking nut locking the wire connector to the upright pole to maintain the rigid wire horizontal and the flag laterally outstretched from the pole.
the decorative flag in combination with the flag pole, where the flag sleeve is slipped over the pole and the wire connector is securely tightened to the pole by the locking nut.

2. The decorative flag and in claim 1, where the upright pole and upwardly extending pin are circular, where the connector opening is larger than the diameter of the extending pin but smaller than the diameter of the upright pole to provide secure vertical support of the marking flag outstretched at a right angle to the upright pole.

3. The decorative flag in claim 1 where the wire end connector comprises one or more turns of rigid wire, and the locking nut engaging the connector turns provide secure locking with the tightened locking nut.

4. The decorative flag in claim 1 where the horizontally disposed rigid wire is bent at least once in the horizontal orientation to provide at least one vertical fold in the outstretched flag to simulate a wavy flag.

5. The decorative flag in claim 4, where the rigid wire contains two or more horizontal bends to provide a vertical fold in the flag at each bend to simulate a wavy flag.

6. The decorative flag in claim 1, where the flag sleeve contains a removable tubular insert with an inside diameter larger than the diameter of the upright pole to provide wear resistance to the flag about the upright pole.

7. The decorative flag and pole assembly in claiml, where the flagpole is removably supported in a ground socket.

8. The decorative flag and pole assembly in claimi, where the flagpole is vertically supported in a freestanding weighted holder attached to the bottom of the pole.

9. A decorative flag and flag pole assembly, where the flagpole is vertically supported in a freestanding weighted holder attached to the bottom of the pole,
the decorative flag for attachment to an upright pole to provide a flag and pole assembly, the upright pole having an upwardly extending pin member attached to the upper end of the upright pole, the upwardly extending pin having a reduced thickness smaller than the thickness of the upright pole forming a peripheral lateral shoulder at the juncture of the upwardly extending pin and the upper terminal end of the upright pole, the upwardly extending pin having a locking nut adapted to lock the flag at a right angle to the upright pole, the decorative flag adapted to be readily attachable and detachable from the pole, the decorative flag comprising:
a flag having an attachment side for interconnection with the upright pole, the attachment side having a vertically orientated linear sleeve adapted to loosely slip over the upright pole and provide direct attachment of the flag to the upright pole;
the flag having a narrow horizontal lateral sleeve disposed perpendicular to the vertical sleeve, the horizontal sleeve containing a horizontal rigid wire for supporting the flag vertically and maintaining the flag laterally outstretched from the vertical sleeve, the rigid wire end having an exposed end connector disposed in alignment with the vertical sleeve, the wire connector having an opening large enough to engage the upwardly extending pin but smaller than the thickness of the upright pole to enable the wire end connector to rest upon the peripheral lateral shoulder between the upright pin and the terminal end of the upright pole;
the wire connector to adapted to be locked by the locking nut to the upright pole to maintain the rigid wire horizontal and maintain the flag laterally outstretched from the pole;

10. The decorative flag in claim 9, where the pole is removable from the weighted holder.
